(19) United States
(12) Patent Application Publication
(10) Pub. No.: US 2025/0073887 A1
(43) Pub. Date: Mar. 6, 2025

(54) BEAM CLAMP LONG REACH INSTALLATION TOOL

(71) Applicant: Adam Summers, Delray Beach, FL (US)

(72) Inventor: Adam Summers, Delray Beach, FL (US)

(21) Appl. No.: 18/820,463

(22) Filed: Aug. 30, 2024

Related U.S. Application Data
(60) Provisional application No. 63/535,410, filed on Aug. 30, 2023.

(51) Int. Cl. B25G 1/04; B25B 13/06; B25B 23/00

(52) U.S. Cl. CPC B25G 1/043; B25B 13/065; B25B 23/0035

(57) ABSTRACT

A tool is specifically structured for securing a beam clamp to a bar joist for the purpose of securing a support rod to the bar joist for hanging pipe. The tool includes a top piece, a bottom piece and an extension member between the top and bottom pieces to adjust the overall length of the tool. A socket drive on the top of the tool allows for releasable attachment of a socket of the type used in a socket wrench assembly. The bottom of the tool includes a square opening for receiving a ratchet or impact gun for the purpose of rotating the tool and attached socket, thereby tightening the loosening the fastening hardware of the beam clamp.

### BACKGROUND OF THE INVENTION

This non-provisional patent application is based on provisional patent application Ser. No. 63/535,410 filed on Aug. 30, 2023.

### FIELD OF THE INVENTION

The present invention relates to tools for manipulating screw fasteners, such as hex head bolts and square head bolts and, more particularly, to a tool that provides an extended reach to tighten or loosen a fastener, such as the bolt of a beam clamp used for attaching support rods to a bar joist for hanging pipe.

### DESCRIPTION OF THE RELATED ART

In commercial building construction, bar joists are commonly used to support floors and ceilings. A typical bar joist consists of upper and lower parallel chords connected by a series of intersecting supports known as the web. The upper and lower parallel chords are each formed by opposing angle members usually manufactured of steel. Throughout interior spaces of certain types of buildings, it is necessary to support hanging pipes that extend below the ceiling or upper floor deck. In order to secure the hanging pipe, support rods are connected to the bar joist by a beam clamp. More specifically, the beam clamp attaches to the angle portions of the upper or lower chord of the bar joist. In order to securely attach the beam clamp to the bar joist, it is necessary to tighten a screw threaded bolt that typically has a square head. The bolt may also include a hex nut to lock the bolt in the fastened position. However, because bar joists are typically at heights that are at least eight feet above the underlying floor surface, it is difficult to reach the bar joist in order to secure the beam clamp without use of a ladder. Because it is necessary to attach a large number of beam clamps to the bar joist when hanging pipe, it is time consuming and inconvenient to constantly move a ladder and then have to climb up and down the ladder to fasten each beam clamp to the bar joist.

Accordingly, there remains a need for a long reach tool that allows for installation of a beam clamp to a bar joist.

### SUMMARY OF THE INVENTION

A tool is specifically structured for securing a beam clamp to a bar joist for the purpose of securing a support rod to the bar joist for hanging pipe. The tool includes a top piece, a bottom piece and an extension member between the top and bottom pieces to adjust the overall length of the tool. A socket drive on the top of the tool allows for releasable attachment of a socket of the type used in a socket wrench assembly. The bottom of the tool includes a square opening for receiving a ratchet or impact gun for the purpose of rotating the tool and attached socket, thereby tightening the loosening the fastening hardware of the beam clamp.

### BRIEF DESCRIPTION OF THE DRAWINGS

For a fuller understanding of the nature of the present invention, reference should be had to the following detailed description taken in connection with the accompanying drawings in which:

FIG. 1 is a side elevational view showing the long reach installation tool of the present invention;

FIG. 2 is a bottom plan view of the long reach installation tool showing a square opening therein for attachment of a ratchet or impact gun thereto;

FIG. 3 is a perspective view of a typical bar joist, shown in cutaway, and illustrating attachment of a beam clamp and support rod to the lower chord of the bar joist; and

FIG. 4 is a perspective view of a beam clamp.

Like reference numerals refer to like parts throughout the several views of the drawings.

### DETAILED DESCRIPTION OF THE PREFERRED EMBODIMENT

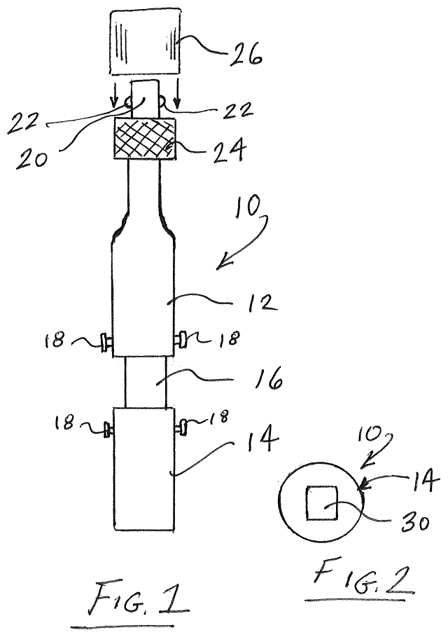

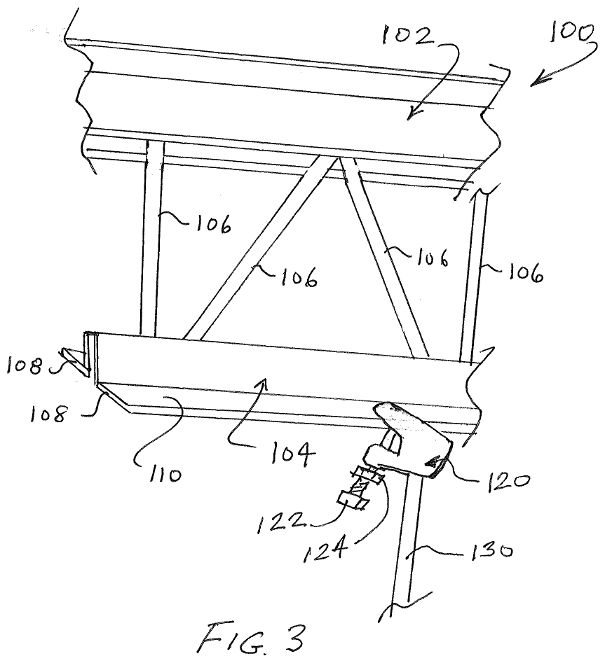

Referring initially to FIGS. 1 and 2, the beam clamp long reach extension tool of the present invention is shown and generally indicated as 10. The long reach installation tool 10 includes a top piece 12 and a bottom piece 14. The top piece 12 and bottom piece 14 are interconnected to one another by an extension member 16 that is secured to both the top piece and the bottom piece by set screws or other fasteners 18. More specifically, the extension member 16 is received within a hollow cavity of both the top piece and the bottom piece and secured by the set screws 18. The extension member 16 is used to provide the desired overall length of the tool. Therefore, a number of extension members 16 are provided, each of a different length, and used as needed for a particular job or task. While the extension member 16 in FIG. 1 is shown as being very short, in most instances, the extension member 16 will be at least 3-4 feet in length and in some cases over 10 feet in length. The long reach installation tool 10 further includes a socket drive 20 on the upper distal end of the top piece 12. The socket drive 20 includes spring biased ball attachment members 22 that allow for releasable and secured attachment of a socket 26 of the type used in a socket wrench assembly. The socket 26 may be a hex socket, a square socket or other shape and size as necessary for the particular task. A lock and release mechanism 24 is operated to release the ball attachment members from secured attachment to the socket, thereby allowing for removal and attachment of the socket 26 onto the socket drive, as needed. The lock and release mechanism is operated by moving the lock and release mechanism downwardly, away from the top distal end of the tool, thereby allowing the ball attachment members 22 to be moved inwardly within the socket drive, so that the socket 26 can be removed from the socket drive. The bottom end of the bottom piece 14 is provided with a square hole 30 that allows for attachment of a ratchet or impact gun thereto in order to facilitate clockwise or counterclockwise rotation of the long reach installation tool 10, the attached socket 26 and a screw fastener, such as the fastening bolt on a beam clamp, as described hereinafter.

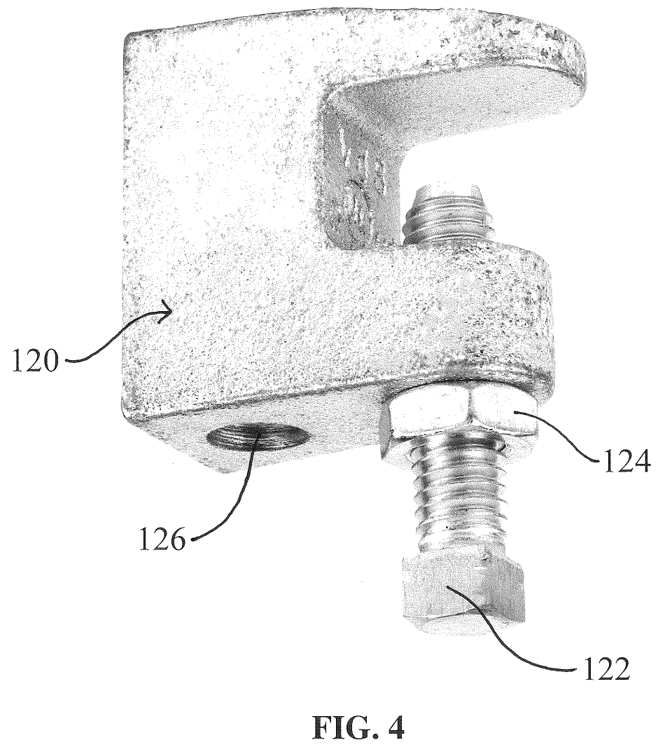

Referring to FIG. 3, an isolated perspective view of a bar joist 100 is shown and includes an upper chord 102 and a lower chord 104. Both the upper chord 102 and the lower chord 104 are formed by opposing angle members 108. The bar joist further includes intersecting supports 106 providing a web between the upper and lower chords 102, 104. The intersecting supports 106 are typically formed of a single bent steel bar. In other instances, sections of a steel bar may be welded together and/or to the opposing angles 108 of the upper and lower chords of the bar joist. As seen in FIG. 3, a beam clamp 120 is secured to the horizontal portion of the angle of either the upper chord 102 or the lower chord 104 of the bar joist 100. In order to securely fasten the beam clamp to the angle of the upper or lower chord of the bar joist, it is necessary to tighten a screw fastener, typically a threaded bolt, that has a square head 122. It may also be necessary to tighten a lock nut 124, using a separate hex socket, in order to securely fasten the beam clamp to the bar joist. The beam clamp 120 includes a female threaded opening 126 that allows for screw threaded attachment of a support rod 130 that extends down from the bar joist 100 in order to support a hanging pipe (not shown). In use, it is necessary to install a number of beam clamps 120 and support rods 130, extending down from the bar joist, at spaced intervals, in order to properly support a hanging pipe. FIG. 4 shows an isolated view of the beam clamp, including the threaded bolt with the square head and lock nut.

The long reach installation tool 10 of the present invention allows for manipulation of a screw fastener, such as a bolt, at a significant distance from the installer. This eliminates the need for the installer to constantly climb up and down a ladder and move the ladder to the next position when attaching beam clamps to one or more bar joists. The long reach installation tool 10 of the present invention may also be used for other purposes, beyond attachment of a beam clamp to a bar joist, in situations where it is very difficult to reach a screw threaded fastener, such as a bolt or screw.

Since many modifications, variations and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A long reach tool for manipulating a threaded fastener, the long reach tool comprising:
an upper member, a lower member and an extension member removably attachable to and extending between the upper member and the lower member;
the upper member including a socket drive for releasable attachment of a socket of a socket wrench assembly; and
the lower member including a bottom end with a multi-sided cavity formed therein for removable attached receipt of a rotating tool to rotate the lower member, the extension member, the upper member, and the attached socket in either a clockwise rotation or a 9 counterclockwise rotation.

2. The long reach tool as recited in claim 1 further comprising a plurality of extension members of varying length and each of the plurality of extension members being structured and disposed for removable attachment to both the upper member and the lower member, and wherein the length of each of the plurality of extension members may be selectively chosen for adjusting the overall length of the long reach tool.

3. The long reach tool as recited in claim 2 wherein the plurality of extension members vary in length from between three feet to at least ten feet.

4. The long reach tool as recited in claim 1 wherein the socket drive includes spring biased ball attachment members that allow for releasable and secured attachment of the socket to the upper member.

5. The long reach tool as recited in claim 4 wherein the socket is a hex socket.

6. The long reach tool as recited in claim 4 wherein the socket is a square socket.
